(19) United States
(12) Patent Application Publication
(10) Pub. No.: US 2021/0086215 A1
(43) Pub. Date: Mar. 25, 2021

(54) ONLINE WATER BLOWING DEVICE FOR WHEEL

(71) Applicant: CITIC Dicastal Co., Ltd., Qinhuangdao (CN)

(72) Inventors: Weidong Liu, Qinhuangdao (CN); Shengchao Zhang, Qinhuangdao (CN); Shiwen Xu, Qinhuangdao (CN)

(21) Appl. No.: 16/831,744

(22) Filed: Mar. 26, 2020

(30) Foreign Application Priority Data
Sep. 25, 2019 (CN) 2019109081774

(51) Int. Cl. B05B 13/02; B08B 3/02

(52) U.S. Cl. CPC B05B 13/0221; B08B 3/024

(57) ABSTRACT

An online wheel water blowing device, comprises wheel positioning part and wheel water blowing part, and can meet requirement of on-line wheel water removal.

### TECHNICAL FIELD

The disclosure relates to a machining post-processing device, in particular to a device for removing residual moisture of a wheel by blowing compressed air matched with a rotating device onto the wheel.

### BACKGROUND

After the machining is finished, cutting fluid and a small amount of aluminum scraps can be remained on the wheel, in order to ensure that the subsequent spraying work is smoothly carried out and improve the yield of the spraying process, after the machining process is finished, a wheel cleaning process is carried out, the cutting fluid and the small amount of aluminum scraps remained in the wheel are removed through high-temperature clear water, the water on the surface of the wheel is removed through different water removing methods, and finally the spraying process can be carried out to finish the wheel coating.

### SUMMARY

The disclosure aims to provide an online wheel water blowing device.

In order to realize the purpose, the technical scheme of the disclosure is as follows: an online water blowing device for a wheel, comprises a wheel positioning part and a wheel water blowing part.

The wheel positioning part is formed by a support frame, an air cylinder, guide shaft bases, linear bearings, hole usable circlips, guide shafts, a lifting shaft, a connecting plate, a motor mounting rack, a servo motor A, a planetary gear reducer, a gear shaft, a power gear, a roller way rack, a conveying roller, a floating mandril, a spring, a limiting screw, a mandril base, a limiting block, a base, a driven gear, a driving belt, a gland, radial bears, spacing rings, pressure bearings, a rotating shaft and a rotating base.

The support frame and the roller way rack are fixed on a foundation, and the conveying roller is mounted on the roller way rack; the air cylinder and the guide shaft bases are fixed on the support frame; the linear bearings and the guide shafts are sealed inside the guide shaft bases through the guide shaft bases and the hole usable circlips; the other ends of the guide shafts are fixed on the connecting plate, one end of the lifting shaft is connected with the air cylinder, and the other end of the lifting shaft is fixed on the connecting plate; the rotating base and the motor mounting rack are mounted on the connecting plate, and the radial bears, the pressure bearings and the spacing rings are sealed inside the rotating base through the gland and the rotating base; the rotating shaft is mounted on the rotating base, and the driven gear is mounted on the rotating shaft; the servo motor A and the planetary gear reducer are mounted on the motor mounting rack, the planetary gear reducer is connected with the power gear through the gear shaft, and the driving belt is connected with the power gear and the driven gear; the base is fixed on the driven gear, the mandril base is mounted on the base, the rotating shaft and the power gear drive the driven gear to rotate through the driving belt; and the spring and the floating mandril are sealed inside the mandril base through the limiting block, the limiting screw and the mandril base.

The air cylinder is mounted on the support frame, and the air cylinder and the lifting shaft control the lifting and lowering of the connecting plate, so as to move the wheel positioning part and the wheel water blowing part up and down.

The guide shaft bases are mounted on the support frame, and the linear bearings and the guide shafts are sealed inside the guide shaft bases through the hole usable circlips.

The driving belt is connected with the power gear and the driven gear, and the driven gear can rotate the floating positioning portion by the servo motor A, the planetary gear reducer, the gear shaft, the power gear and the driving belt.

The driven gear is mounted at a top of the rotating shaft, the base is mounted on the driven gear, and the driven gear may drive the rotating shaft and the base to rotate.

The mandril base is fixedly arranged on the base, the spring and the floating mandril are sealed inside the mandril base through the limiting block and the limiting screw, and the spring is in the middle of the mandril base.

A chute body is arranged in the middle of the floating mandril and is matched with the limiting screw and the mandril base.

A top of the floating mandril is provided with two conical surfaces.

The floating mandril can float up and down, and one floating mandril can meet the positioning requirements of all wheel blanks with the size of the central hole part within a certain range, so that the universality of the floating mandril is realized, and the production cost is saved.

The wheel water blowing part is formed by a mounting rack, spray nozzles, spray nozzle support frames, mounting seats and sliding chutes.

The mounting rack is fixedly arranged on the roller way rack and is provided with a series of sliding chutes, the mounting seats are mounted in the sliding chutes of the mounting rack, and the spray nozzles are mounted on the mounting seats through the spray nozzle support frames, wherein the mounting seats may be regulated in the sliding chutes, so that the requirement that wheels of different sizes blow water is met.

During actual use, a blank wheel moves to the detection platform through the conveying roller, the air cylinder is ventilated to drive the rotating part and the floating positioning part to integrally ascend, the central hole part of the blank wheel is in contact with the conical surface of the mandril base, the mandril base moves downwards under the action of the gravity of the blank wheel, the conical surface of the mandril base is in complete contact with the central hole part of the blank wheel, and the blank wheel ascends to a specified height under the action of the lifting force of the air cylinder. At this time, the servo motor A starts to operate, and drives the rotating shaft, the floating positioning part and the wheel to start rotating, and meanwhile, high-pressure air is introduced, high-pressure air sprayed from the spray nozzles blows to the wheel, and the spray head can be blown off through water at any position on the wheel. And finishing the work of removing the residual water on the wheel.

The disclosure can meet the requirement of online dewatering of the wheel, has the characteristics of simple structure, reliable work, stable performance, simple operation and the like, and is very suitable for mechanical batch production.

### BRIEF DESCRIPTION OF FIGURES

FIG. 1 is a schematic structural view of the wheel on-line water blowing device in operation.

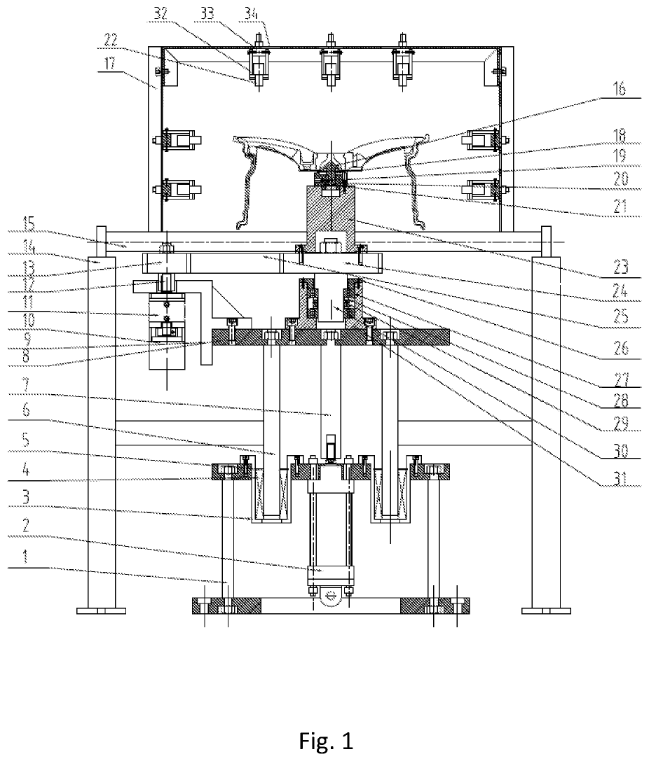

In the FIGURES, 1—a support frame, 2—an air cylinder, 3—guide shaft bases 3, 4—linear bearings 4, 5—hole usable circlips, 6—guide shafts, 7—a lifting shaft, 8—a connecting plate, 9—a motor mounting rack, 10—a servo motor A, 11—a planetary gear reducer, 12—a gear shaft, 13—a power gear, 14—a roller way rack, 15—a conveying roller, 16—a floating mandril, 17—the mounting rack 18—a spring, 19—a limiting screw, 20—a mandril base, 21—a limiting block, 22 spray nozzles, 23—a base, 24—a driven gear, 25—a driving belt, 26—a gland, 27—radial bears, 28—spacing rings, 29—pressure bearings, 30—a rotating shaft, 31—a rotating base, 32—spray nozzle support frames, 33—mounting seats, 34—sliding chutes.

### DETAILED DESCRIPTION

The details and operation of the particular apparatus proposed according to the present disclosure are explained in detail below with reference to the accompanying drawings.

The disclosure relates to an online water blowing device for a wheel, comprises a wheel positioning part and a wheel water blowing part.

The wheel positioning part is formed by a support frame 1, an air cylinder 2, guide shaft bases 3, linear bearings 4, hole usable circlips 5, guide shafts 6, a lifting shaft 7, a connecting plate 8, a motor mounting rack 9, a servo motor A 10, a planetary gear reducer 11, a gear shaft 12, a power gear 13, a roller way rack 14, a conveying roller 15, a floating mandril 16, a spring 18, a limiting screw 19, a mandril base 20, a limiting block 21, a base 23, a driven gear 24, a driving belt 25, a gland 26, radial bears 27, spacing rings 28, pressure bearings 29, a rotating shaft 30 and a rotating base 31.

The support frame 1 and the roller way rack 14 are fixed on a foundation, and the conveying roller 15 is mounted on the roller way rack 14; the air cylinder 2 and the guide shaft bases 3 are fixed on the support frame 1; the linear bearings 4 and the guide shafts 6 are sealed inside the guide shaft bases 3 through the guide shaft bases 3 and the hole usable circlips 5; the other ends of the guide shafts 6 are fixed on the connecting plate 8, one end of the lifting shaft 7 is connected with the air cylinder 2, and the other end of the lifting shaft 7 is fixed on the connecting plate 8; the rotating base 31 and the motor mounting rack 9 are mounted on the connecting plate 8, and the radial bears 27, the pressure bearings 29 and the spacing rings 28 are sealed inside the rotating base 31 through the gland 26 and the rotating base 31; the rotating shaft 30 is mounted on the rotating base 31, and the driven gear 24 is mounted on the rotating shaft 30; the servo motor A 10 and the planetary gear reducer 11 are mounted on the motor mounting rack 9, the planetary gear reducer 11 is connected with the power gear 13 through the gear shaft 12, and the driving belt 25 is connected with the power gear 13 and the driven gear 24; the base 23 is fixed on the driven gear 24, the mandril base 20 is mounted on the base 23, the rotating shaft 30 and the power gear 13 drive the driven gear 24 to rotate through the driving belt 25; and the spring 18 and the floating mandril 16 are sealed inside the mandril base 20 through the limiting block 21, the limiting screw 19 and the mandril base 20;

In an aspect of the present disclosure, The air cylinder 2 is mounted on the support frame 1, and the air cylinder 2 and the lifting shaft 7 control the lifting and lowering of the connecting plate 8, so as to move the wheel positioning part and the wheel water blowing part up and down.

In an aspect of the present disclosure, the guide shaft bases 3 are mounted on the support frame 1, and the linear bearings 4 and the guide shafts 6 are sealed inside the guide shaft bases 3 through the hole usable circlips 5. the four guide shafts 6 ensure smooth movement of the rotating part and the positioning part, and prevent the connecting plate 8 from rotating in the circumferential direction.

In an aspect of the present disclosure, the driving belt 25 is connected with the power gear 13 and the driven gear 24, and the driven gear 24 can rotate the floating positioning portion by the servo motor A10, the planetary gear reducer 11, the gear shaft 12, the power gear 13 and the driving belt 25.

In an aspect of the present disclosure, the driven gear 24 is mounted at a top of the rotating shaft 30, the base 23 is mounted on the driven gear 24, and the driven gear 24 may drive the rotating shaft 30 and the base 23 to rotate.

In an aspect of the present disclosure, the mandril base 20 is fixedly arranged on the base 23, the spring 18 and the floating mandril 16 are sealed inside the mandril base 20 through the limiting block 21 and the limiting screw 19, and the spring 18 is located in the middle of the mandril base 20. and the floating mandril 16 can smoothly float up and down under the action of the spring 18.

In an aspect of the present disclosure, a chute body is arranged in the middle of the floating mandril 16 and is matched with the limiting screw 19 and the mandril base 20, and the groove cooperates with the limit screw 19 and the roof core base 20 to limit the floating range of the floating mandril 16, prevent floating mandril 16 from rotating circumferentially, and ensure the positioning accuracy of the vehicle.

In an aspect of the disclosure, a top of the floating mandril 16 is provided with two conical surfaces, the first of which is used for guiding and the second of which is positioned in contact with the central bore portion of the wheel blank.

In an aspect of the present disclosure, since floating mandril 16 can float up and down, one floating mandril 16 can be adapted to the positioning requirements of all wheel blanks having a center hole portion with a size within a certain range, thereby achieving the generalization of the floating mandril 16 and saving the production cost.

The wheel water blowing part is formed by a mounting rack 17, spray nozzles 22, spray nozzle support frames 32, mounting seats 33 and sliding chutes 34.

The mounting rack 17 is fixedly arranged on the roller way rack 14 and is provided with a series of sliding chutes 34, the mounting seats 33 are mounted in the sliding chutes 34 of the mounting rack 17, and the spray nozzles 22 are mounted on the mounting seats 33 through the spray nozzle support frames 32, wherein the mounting seats 33 may be regulated in the sliding chutes 34, so that the requirement that wheels of different sizes blow water is met.

During actual use, a blank wheel moves to the detection platform through the conveying roller 15, the air cylinder 2 is ventilated to drive the rotating part and the floating positioning part to integrally ascend, the central hole part of the blank wheel is in contact with the conical surface of the mandril base 20, the mandril base 20 moves downwards under the action of the gravity of the blank wheel, the conical surface of the mandril base 20 is in complete contact with the central hole part of the blank wheel, and the blank wheel ascends to a specified height under the action of the lifting force of the air cylinder 2. At this time, the servo motor A10 starts to operate, and drives the rotating shaft 30, the floating positioning part and the wheel to start rotating, and meanwhile, high-pressure air is introduced, high-pressure air sprayed from the spray nozzles 22 blows to the wheel, and the spray head can be blown off through water at any position on the wheel. And finishing the work of removing the residual water on the wheel.

What is claimed is:

1. An online water blowing device for a wheel, comprising a wheel positioning part and a wheel water blowing part, wherein
the wheel positioning part is formed by a support frame, an air cylinder, guide shaft bases, linear bearings, hole usable circlips, guide shafts, a lifting shaft, a connecting plate, a motor mounting rack, a servo motor A, a planetary gear reducer, a gear shaft, a power gear, a roller way rack, a conveying roller, a floating mandril, a spring, a limiting screw, a mandril base, a limiting block, a base, a driven gear, a driving belt, a gland, radial bears, spacing rings, pressure bearings, a rotating shaft and a rotating base;
the support frame and the roller way rack are fixed on a foundation, and the conveying roller is mounted on the roller way rack; the air cylinder and the guide shaft bases are fixed on the support frame; the linear bearings and the guide shafts are sealed inside the guide shaft bases through the guide shaft bases and the hole usable circlips; the other ends of the guide shafts are fixed on the connecting plate, one end of the lifting shaft is connected with the air cylinder, and the other end of the lifting shaft is fixed on the connecting plate; the rotating base and the motor mounting rack are mounted on the connecting plate, and the radial bears, the pressure bearings and the spacing rings are sealed inside the rotating base through the gland and the rotating base; the rotating shaft is mounted on the rotating base, and the driven gear is mounted on the rotating shaft; the servo motor A and the planetary gear reducer are mounted on the motor mounting rack, the planetary gear reducer is connected with the power gear through the gear shaft, and the driving belt is connected with the power gear and the driven gear; the base is fixed on the driven gear, the mandril base is mounted on the base, the rotating shaft and the power gear drive the driven gear to rotate through the driving belt; and the spring and the floating mandril are sealed inside the mandril base through the limiting block, the limiting screw and the mandril base;
the wheel water blowing part is formed by a mounting rack, spray nozzles, spray nozzle support frames, mounting seats and sliding chutes; and
the mounting rack is fixedly arranged on the roller way rack and is provided with a series of sliding chutes, the mounting seats are mounted in the sliding chutes of the mounting rack, and the spray nozzles are mounted on the mounting seats through the spray nozzle support frames, wherein the mounting seats may be regulated in the sliding chutes.

2. The online water blowing device for the wheel according to claim 1, wherein the air cylinder is mounted on the support frame.

3. The online water blowing device for the wheel according to claim 1, wherein the guide shaft bases are mounted on the support frame, and the linear bearings and the guide shafts are sealed inside the guide shaft bases through the hole usable circlips.

4. The online water blowing device for the wheel according to claim 1, wherein the driving belt relates to the power gear and the driven gear.

5. The online water blowing device for the wheel according to claim 1, wherein the driven gear is mounted at a top of the rotating shaft, the base is mounted on the driven gear, and the driven gear may drive the rotating shaft and the base to rotate.

6. The online water blowing device for the wheel according to claim 1, wherein the mandril base is fixedly arranged on the base, the spring and the floating mandril are sealed inside the mandril base through the limiting block and the limiting screw, and the spring is located in the middle of the mandril base.

7. The online water blowing device for the wheel according to claim 1, wherein a chute body is arranged in the middle of the floating mandril and is matched with the limiting screw and the mandril base.

8. The online water blowing device for the wheel according to claim 1, wherein a top of the floating mandril is provided with two conical surfaces.
